(19) United States
(12) Patent Application Publication
(10) Pub. No.: US 2023/0335803 A1
(43) Pub. Date: Oct. 19, 2023

(54) SPIRALLY-WOUND BATTERY STRUCTURE AND METHOD FOR PRODUCING THE SAME

(71) Applicant: PHOENIX BATTERY CORPORATION, Hsinchu City (TW)

(72) Inventors: Chin-Chia CHEN, Hsinchu City (TW); Ching-Fei LI, Hsinchu City (TW); Hsiu-Chuan CHEN, Hsinchu City (TW); Ta-Kuang HUNG, Hsinchu City (TW); Yu-Hsien FU, Hsinchu City (TW)

(21) Appl. No.: 17/720,554

(22) Filed: Apr. 14, 2022

(51) Int. Cl. H01M 10/0587; H01M 50/536; H01M 50/534

(52) U.S. Cl. CPC H01M 10/0587; H01M 50/536; H01M 50/534

(57) ABSTRACT

A spirally-wound battery structure and a method for producing the same is provided. In the method, a power-supplying electrode plate spirally winds a hollow cylinder and has first conductive tabs and second conductive tabs. A first conductive terminal plate and a second conductive terminal plate are inserted into the hollow cylinder. Conductive welding sheets sleeve the conductive terminal plates to clamp the conductive tabs between the conductive welding sheet and the conductive terminal plate. The conductive welding sheet, the conductive tabs, and the conductive terminal plate are welded with laser. A casing encapsulates the hollow cylinder, the power-supplying electrode plate, the first conductive tabs, the second conductive tabs, the first conductive welding sheet, and the second conductive welding sheet. The first conductive terminal plate and the second conductive terminal plate penetrate through the casing.

### BACKGROUND OF THE INVENTION

### Field of the Invention

The present invention relates to a battery-producing technology, particularly to a spirally-wound battery structure and a method for producing the same.

### Description of the Related Art

Lithium-ion batteries have attracted much attention due to their high operating voltage, high energy density, long cycle life, low self-discharge rate, and “green” environmental protection. Therefore, lithium-ion batteries are widely used in various fields, especially in mobile phones and electronic industries. The structure, performance and manufacturing process of lithium-ion batteries will be endlessly improved. With the development of lithium-ion batteries, the automotive industry is gradually powered by lithium-ion batteries. At present, the main structures of lithium-ion batteries are classified into laminated and spirally-wound structures.

A spirally-wound battery structure includes a battery cell, a conductive terminal plate, and an electricity-collecting press plate. The battery cell has conductive tabs that cover the conductive terminal plate. The electricity-collecting press plate covers the conductive tabs. In order to facilitate automatic production and prevent the conductive tabs from falling off, the electricity-collecting press plate and the conductive terminal plate clamp the conductive tabs tightly. When the power output of the battery structure is increased, the number of the conductive tabs is increased. Since the conductive tabs, the electricity-collecting press plate, and the conductive terminal plate are not welded together, the conductive tabs move relative to the electricity-collecting press plate and the conductive terminal plate. The touch impedance of the battery structure increases such that the resistance of the battery structure increases, drifts, and diverges when the number of the conductive tabs increases. In a conventional technology, the conductive tabs and the conductive terminal plate are welded with laser, and then the electricity-collecting press plate covers the conductive tabs. The battery cell has an electrode sheet. The main area of the electrode sheet has an electrode coating, and the other area of the electrode sheet does not have any electrode coating but serves as an empty foil and the conductive tabs. The empty foil is formed between the conductive tab and the main area. In order to avoid a short-circuit event caused by a fact that laser destroys an insulation film between a positive electrode sheet and a negative electrode sheet of the battery cell, the width of the empty foil of the electrode sheet is increased.

Since the volume of the battery structure is fixed, the areas of the positive electrode sheet and the negative electrode sheet have to decrease to reduce the output power of the battery structure when the area of the empty foil of the electrode sheet increases. Alternatively, the conductive terminal plate is connected to conductive terminals by riveting or spot welding. However, the welding procedures are more complicated, and the components need to be precisely machined by computer numerical control (CNC). Thus, the cost of the components is higher and the locations of the welding points are unevenly distributed.

To overcome the abovementioned problems, the present invention provides a spirally-wound battery structure and a method for producing the same, so as to solve the afore-mentioned problems of the prior art.

### SUMMARY OF THE INVENTION

The present invention provides a spirally-wound battery structure and a method for producing the same, which greatly reduce the probability of heat accumulation and the risk of destroying an insulation film at high temperature, guarantee an electrical connection between a conductive terminal plate and conductive tabs, avoid point discharging and the increase, drift, and divergence the resistance of the battery structure when the conductive tabs non-uniformly touch the conductive terminal plate, improve the usage of space within the battery structure, and increase the effective area of an electrode sheet to increase electric power.

In an embodiment of the present invention, a method for producing a spirally-wound battery structure includes: by a power-supplying electrode plate, spirally winding the sidewall of a hollow cylinder, wherein the power-supplying electrode plate has a first side edge and a second side edge, the first side edge and the second side edge are opposite to each other, the first side edge extends outward to form first conductive tabs, the second side edge extends outward to form second conductive tabs, the first conductive tabs separate from each other, and the second conductive tabs separate from each other; inserting a first conductive terminal plate and a second conductive terminal plate into the hollow cylinder, wherein the first conductive terminal plate and the second conductive terminal plate are opposite to each other; by a first conductive welding sheet, sleeving the first conductive terminal plate to clamp the first conductive tabs between the first conductive terminal plate and the first conductive welding sheet, and welding the first conductive welding sheet, the first conductive tabs, and the first conductive terminal plate with laser; by a second conductive welding sheet, sleeving the second conductive terminal plate to clamp the second conductive tabs between the second conductive terminal plate and the second conductive welding sheet, and welding the second conductive welding sheet, the second conductive tabs, and the second conductive terminal plate with laser; and by a casing, encapsulating the hollow cylinder, the power-supplying electrode plate, the first conductive tabs, the second conductive tabs, the first conductive welding sheet, and the second conductive welding sheet, wherein the first conductive terminal plate and the second conductive terminal plate penetrate through the casing.

In an embodiment of the present invention, the power-supplying electrode plate further includes a positive electrode sheet and a negative electrode sheet. One side edge of the positive electrode sheet has the first conductive tabs. One side edge of the negative electrode sheet has the second conductive tabs. An insulation film is arranged between the positive electrode sheet and the negative electrode sheet. The positive electrode sheet, the negative electrode sheet, and the insulation film wind the sidewall of the hollow cylinder.

In an embodiment of the present invention, after the step of welding the second conductive welding sheet, the second conductive tabs, and the second conductive terminal plate, a first press plate and a second press plate respectively sleeve the first conductive terminal plate and the second conductive terminal plate, and then the casing encapsulates the hollow cylinder, the power-supplying electrode plate, the first conductive tabs, the second conductive tabs, the first press plate, the second press plate, the first conductive welding sheet, and the second conductive welding sheet.

In an embodiment of the present invention, the method further includes a step of respectively sleeving the first conductive terminal plate and the second conductive terminal plate with a first conductive terminal and a second conductive terminal The first conductive terminal and the second conductive terminal are arranged outside the casing.

In an embodiment of the present invention, the shortest difference between the outer edge of the first conductive welding sheet and a position where the first conductive welding sheet welds the first conductive tabs and the first conductive terminal plate is R1. R1>0. The length of each of the first conductive tabs that overlaps the first conductive terminal plate and the first conductive welding sheet is larger than or equal to 0.2R1.

In an embodiment of the present invention, the shortest difference between the outer edge of the second conductive welding sheet and a position where the second conductive welding sheet welds the second conductive tabs and the second conductive terminal plate is R2. R2>0.

The length of each of the second conductive tabs that overlaps the second conductive terminal plate and the second conductive welding sheet is larger than or equal to 0.2R2.

In an embodiment of the present invention, the thickness of each of the first conductive welding sheet and the second conductive welding sheet ranges from 100 to 300 μm.

In an embodiment of the present invention, a spirally-wound battery structure includes a hollow cylinder, a power-supplying electrode plate, a first conductive terminal plate, a second conductive terminal plate, a first conductive welding sheet, a second conductive welding sheet, and a casing. The power-supplying electrode plate spirally winds the sidewall of the hollow cylinder. The power-supplying electrode plate has a first side edge and a second side edge. The first side edge and the second side edge are opposite to each other. The first side edge extends outward to form first conductive tabs. The second side edge extends outward to form second conductive tabs. The first conductive tabs separate from each other. The second conductive tabs separate from each other. The first conductive terminal plate and the second conductive terminal plate are arranged opposite to each other and inserted into the hollow cylinder. The first conductive welding sheet sleeves the first conductive terminal plate. The first conductive tabs are clamped between the first conductive terminal plate and the first conductive welding sheet. The first conductive welding sheet welds the first conductive terminal plate through the first conductive tabs. The second conductive welding sheet sleeves the second conductive terminal plate. The second conductive tabs are clamped between the second conductive terminal plate and the second conductive welding sheet. The second conductive welding sheet welds the second conductive terminal plate through the second conductive tabs. The casing encapsulates the hollow cylinder, the power-supplying electrode plate, the first conductive tabs, the second conductive tabs, the first conductive welding sheet, and the second conductive welding sheet. The first conductive terminal plate and the second conductive terminal plate penetrate through the casing.

In an embodiment of the present invention, the power-supplying electrode plate further includes a positive electrode sheet and a negative electrode sheet. One side edge of the positive electrode sheet has the first conductive tabs. One side edge of the negative electrode sheet has the second conductive tabs. An insulation film is arranged between the positive electrode sheet and the negative electrode sheet. The positive electrode sheet, the negative electrode sheet, and the insulation film wind the sidewall of the hollow cylinder.

In an embodiment of the present invention, the positive electrode sheet includes aluminum and the negative electrode sheet includes copper.

In an embodiment of the present invention, the first conductive welding sheet includes aluminum or stainless steel, and the second conductive welding sheet includes copper, nickel, stainless steel.

In an embodiment of the present invention, the spirally-wound battery structure further includes a first press plate and a second press plate. The first press plate, sleeving the first conductive terminal plate, is arranged between the casing and the first conductive welding sheet. The second press plate, sleeving the second conductive terminal plate, is arranged between the casing and the second conductive welding sheet.

In an embodiment of the present invention, the spirally-wound battery structure further includes a first conductive terminal and a second conductive terminal The first conductive terminal, sleeving the first conductive terminal plate, is arranged outside the casing. The second conductive terminal, sleeving the second conductive terminal plate, is arranged outside the casing.

In an embodiment of the present invention, the first conductive terminal plate includes a first conductive plate. The top and the bottom of the first conductive plate respectively have a first conductive protrusion and a second conductive protrusion. The first conductive protrusion is inserted into the hollow cylinder. The first conductive welding sheet sleeves the second conductive protrusion. The first conductive tabs are clamped between the first conductive plate and the first conductive welding sheet. The first conductive welding sheet welds the first conductive plate through the first conductive tabs. The second conductive protrusion penetrates through the casing.

In an embodiment of the present invention, the second conductive terminal plate includes a second conductive plate. The top and the bottom of the second conductive plate respectively have a third conductive protrusion and a fourth conductive protrusion. The third conductive protrusion is inserted into the hollow cylinder. The second conductive welding sheet sleeves the fourth conductive protrusion. The second conductive tabs are clamped between the second conductive plate and the second conductive welding sheet. The second conductive welding sheet welds the second conductive plate through the second conductive tabs. The fourth conductive protrusion penetrates through the casing.

In an embodiment of the present invention, the shortest difference between the outer edge of the first conductive welding sheet and a position where the first conductive welding sheet welds the first conductive tabs and the first conductive terminal plate is R1. R1>0. The length of each of the first conductive tabs that overlaps the first conductive terminal plate and the first conductive welding sheet is larger than or equal to 0.2R1.

In an embodiment of the present invention, the shortest difference between the outer edge of the second conductive welding sheet and a position where the second conductive welding sheet welds the second conductive tabs and the second conductive terminal plate is R2. R2>0. The length of each of the second conductive tabs that overlaps the second conductive terminal plate and the second conductive welding sheet is larger than or equal to 0.2R2.

In an embodiment of the present invention, the thickness of each of the first conductive welding sheet and the second conductive welding sheet ranges from 100 to 300 μm.

To sum up, the spirally-wound battery structure and the method for producing the same rapidly weld the conductive welding sheets, the conductive tabs, and the conductive terminal plates with laser to greatly reduce the probability of heat accumulation, and employ the conductive welding sheets and the conductive terminal plates to reduce the risk of destroying the insulation film at high temperature. Laser points are continuously and easily formed along the edge of the conductive welding sheet to guarantee an electrical connection between the conductive terminal plate and the conductive tabs and to avoid point discharging when the conductive tabs non-uniformly touch the conductive terminal plate. Thus, the usage of space within the battery structure is improved to increase the effective area of the electrode sheet and electric power.

Besides, there is no need for a secondary precision machining to flatten the welding surface of the conductive terminal plate. The spirally-wound battery structure can be automatically produced. The conductive tabs and the widths of the empty foil of the electrode sheet are not increased, which can avoid the increase, drift and divergence of the resistance value of the battery structure.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view of a spirally-wound battery structure according to an embodiment of the present invention;

FIG. 2 is an exploded view of a spirally-wound battery structure according to an embodiment of the present invention;

FIG. 3 is a cross-sectional view of a spirally-wound battery structure according to an embodiment of the present invention;

FIG. 4(a) is a schematic diagram illustrating the welding positions of a first conductive welding sheet, a first conductive terminal plate, and first conductive tabs according to an embodiment of the present invention;

FIG. 4(b) is a schematic diagram illustrating the welding positions of a second conductive welding sheet, a second conductive terminal plate, and second conductive tabs according to an embodiment of the present invention; and

FIG. 5 is a flowchart of a method for producing a spirally-wound battery structure according to an embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the article “a” and “the” includes the meaning of “one or at least one” of the element or component. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. Every example in the present specification cannot limit the claimed scope of the invention.

Further, in the present specification and claims, the term “comprising” is open type and should not be viewed as the term “consisted of” Besides, the term “electrically coupled” can be referring to either directly connecting or indirectly connecting between elements. Thus, if it is described in the below contents of the present invention that a first device is electrically coupled to a second device, the first device can be directly connected to the second device, or indirectly connected to the second device through other devices or means. Moreover, when the transmissions or generations of electrical signals are mentioned, one skilled in the art should understand some degradations or undesirable transformations could be generated during the operations. If it is not specified in the specification, an electrical signal at the transmitting end should be viewed as substantially the same signal as that at the receiving end. For example, when the end A of an electrical circuit provides an electrical signal S to the end B of the electrical circuit, the voltage of the electrical signal S may drop due to passing through the source and drain of a transistor or due to some parasitic capacitance. However, the transistor is not deliberately used to generate the effect of degrading the signal to achieve some result, that is, the signal S at the end A should be viewed as substantially the same as that at the end B.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment.

Unless otherwise specified, some conditional sentences or words, such as “can”, “could”, “might”, or “may”, usually attempt to express that the embodiment in the present invention has, but it can also be interpreted as a feature, element, or step that may not be needed. In other embodiments, these features, elements, or steps may not be required.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The spirally-wound battery structure and the method for producing the same are provided as follows. The spirally-wound battery structure and the method for producing the same rapidly weld conductive welding sheets, conductive tabs, and conductive terminal plates with laser to greatly reduce the probability of heat accumulation, and employ the conductive welding sheets and the conductive terminal plates to reduce the risk of destroying an insulation film at high temperature. Laser points are continuously and easily formed along the edge of the conductive welding sheet to guarantee an electrical connection between the conductive terminal plate and the conductive tabs and to avoid point discharging when the conductive tabs non-uniformly touch the conductive terminal plate. Thus, the usage of space within the battery structure is improved to increase the effective area of the electrode sheet and electric power. Besides, there is no need for a secondary precision machining to flatten the welding surface of the conductive terminal plate. The spirally-wound battery structure can be automatically produced.—The conductive tabs and the widths of the empty foil of the electrode sheet are not increased, which can avoid the increase, drift and divergence of the resistance value of the battery structure.

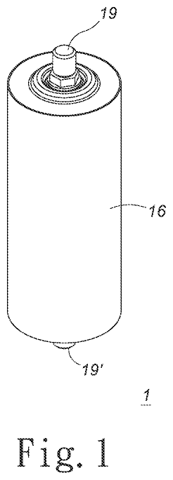

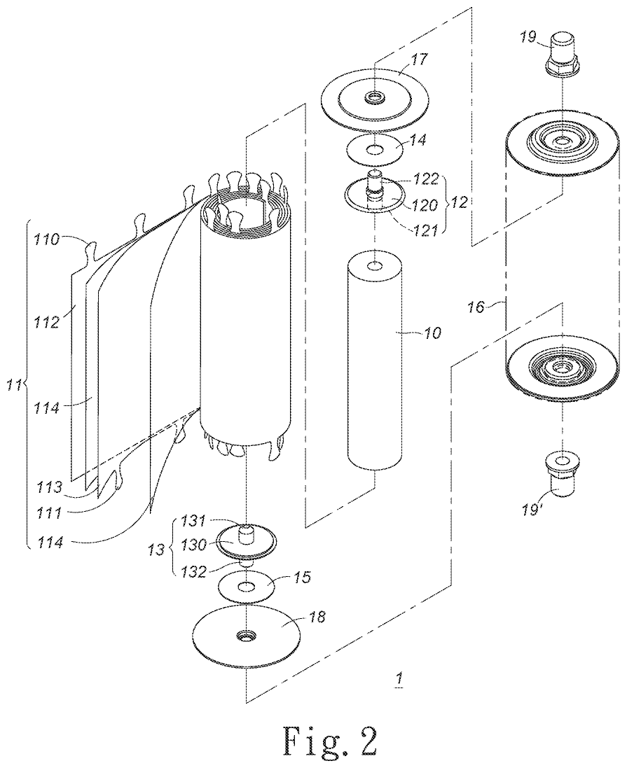

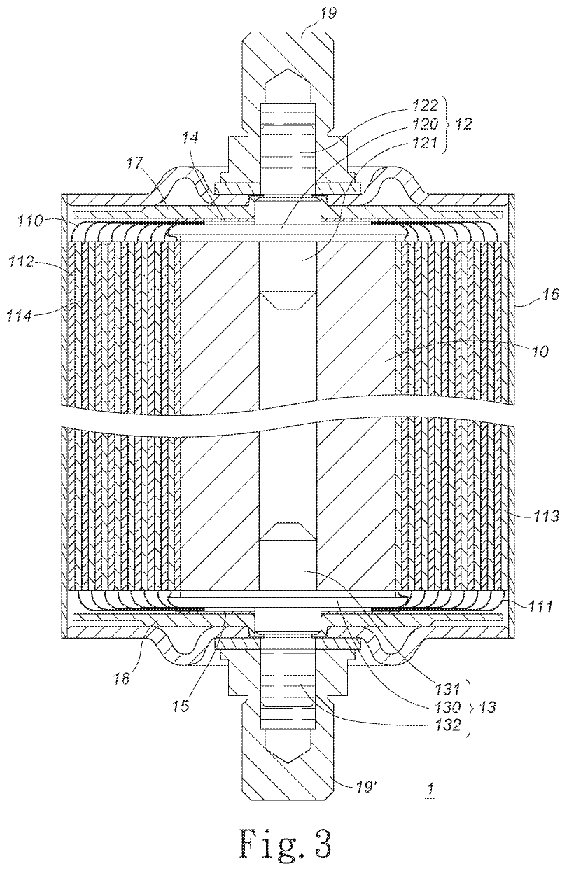

FIG. 1 is a perspective view of a spirally-wound battery structure according to an embodiment of the present invention. FIG. 2 is an exploded view of a spirally-wound battery structure according to an embodiment of the present invention. FIG. 3 is a cross-sectional view of a spirally-wound battery structure according to an embodiment of the present invention. Referring to FIG. 1, FIG. 2, and FIG. 3, a spirally-wound battery structure 1 is introduced as follows. The spirally-wound battery structure 1 includes a hollow cylinder 10, a power-supplying electrode plate 11, a first conductive terminal plate 12, a second conductive terminal plate 13, a first conductive welding sheet 14, a second conductive welding sheet 15, and a casing 16. The hollow cylinder 10 may include an insulating material. The casing 16 may include, but not limited to, conductive metal or an insulating material. Each of the first conductive welding sheet 14 and the second conductive welding sheet 15 may have a thickness of 100˜300 μm, but the present invention is not limited thereto. The power-supplying electrode plate 11 spirally winds the sidewall of the hollow cylinder 10. The power-supplying electrode plate 11 has a first side edge and a second side edge, wherein the first side edge and the second side edge are opposite to each other. The first side edge extends outward to form first conductive tabs 110. The second side edge extends outward to form second conductive tabs 111. The first conductive tabs 110 separate from each other. The second conductive tabs 111 separate from each other. The first conductive terminal plate 12 and the second conductive terminal plate 13 are arranged opposite to each other and inserted into the hollow cylinder 10. The first conductive welding sheet 14 sleeves the first conductive terminal plate 12. The first conductive tabs 110 are clamped between the first conductive terminal plate 12 and the first conductive welding sheet 14. The first conductive welding sheet 14 welds the first conductive terminal plate 12 through the first conductive tabs 110. The second conductive welding sheet 15 sleeves the second conductive terminal plate 13. The second conductive welding sheet 15 welds the second conductive terminal plate 13 through the second conductive tabs 111. The casing 16 encapsulates the hollow cylinder 10, the power-supplying electrode plate 11, the first conductive tabs 110, the second conductive tabs 111, the first conductive welding sheet 14, and the second conductive welding sheet 15. The first conductive terminal plate 12 and the second conductive terminal plate 13 penetrate through the casing 16. The size of the spirally-wound battery structure 1 is not limited. The casing 16 may have a shape of cylinder. The cylinder may have a cross-sectional diameter of 40 mm or 46 mm, but the present invention is not limited thereto.

In an embodiment, the first conductive terminal plate 12 include a first conductive plate 120. The top and the bottom of the first conductive plate 120 respectively have a first conductive protrusion 121 and a second conductive protrusion 122. The first conductive protrusion 121 is inserted into the hollow cylinder 10. The first conductive welding sheet 14 sleeves the second conductive protrusion 122. The first conductive tabs 110 are clamped between the first conductive plate 120 and the first conductive welding sheet 14. The first conductive welding sheet 14 welds the first conductive plate 120 through the first conductive tabs 110. The second conductive protrusion 122 penetrates through the casing 16. The second conductive terminal plate 13 includes a second conductive plate 130. The top and the bottom of the second conductive plate 130 respectively have a third conductive protrusion 131 and a fourth conductive protrusion 132. The third conductive protrusion 131 is inserted into the hollow cylinder 10. The second conductive welding sheet 15 sleeves the fourth conductive protrusion 132. The second conductive tabs 111 are clamped between the second conductive plate 130 and the second conductive welding sheet 15. The second conductive welding sheet 15 welds the second conductive plate 130 through the second conductive tabs 111. The fourth conductive protrusion 132 penetrates through the casing 16.

In some embodiments of the present invention, the power-supplying electrode plate 11 may further include a positive electrode sheet 112 and a negative electrode sheet 113. One side edge of the positive electrode sheet 112 has the first conductive tabs 110. One side edge of the negative electrode sheet 113 has the second conductive tabs 111. An insulation film 114 is arranged between the positive electrode sheet 112 and the negative electrode sheet 113. The positive electrode sheet 112, the negative electrode sheet 113, and the insulation film 114 wind the sidewall of the hollow cylinder 10. The positive electrode sheet 112 may include, but not limited to, aluminum. The negative electrode sheet 113 may include, but not limited to, copper. The first conductive welding sheet 14 may include, but not limited to, aluminum or stainless steel. The second conductive welding sheet 15 may include, but not limited to, copper, nickel, or stainless steel. In order to avoid pseudo solder joints, the first conductive welding sheet 14 and the second conductive welding sheet 15 are usually not made of copper. Preferably, all the first conductive tabs 110 may have a total thickness of 0.2˜0.8 mm. All the second conductive tabs 111 may have a total thickness of 0.2˜0.5 mm. An interval between the two adjacent first conductive tabs 110 may be 20˜55 mm. The total number of the first conductive tabs 110 may be 80˜150. The current density of the first conductive tab 110 may be 9.1×10⁴˜1.4×10⁸ A/m². An interval between the two adjacent second conductive tabs 111 may be 30˜55 mm. The total number of the second conductive tabs 111 may be 90˜140. The current density of the second conductive tab 111 may be 1.5×10⁵˜5.6×10⁷ A/m². The positive electrode sheet 112 may include a positive rectangular sheet. The long side of the positive rectangular sheet is provided with the first conductive tabs 110, wherein the long side may be 2000-7000 mm. The negative electrode sheet 113 may include a negative rectangular sheet. The long side of the negative rectangular sheet is provided with the second conductive tabs 111, wherein the long side may be 2100-7100 mm. The main area of the positive electrode sheet 112 has an electrode coating layer and the other area of the positive electrode sheet 112 is used as an empty foil and the first conductive tabs 110. The empty foil is arranged between the main area and the first conductive tabs 110. Similarly, the main area of the negative electrode sheet 113 has an electrode coating layer and the other area of the negative electrode sheet 113 is used as an empty foil and the second conductive tabs 111. The empty foil is arranged between the main area and the second conductive tabs 111.

When the casing 16 is made of conductive metal, the spirally-wound battery structure 1 may further include a first press plate 17 and a second press plate 18. The first press plate 17 and the second press plate 18 may be made of an insulating material. The first press plate 17, sleeving the second conductive protrusion 122 of the first conductive terminal plate 12, is arranged between the casing 16 and the first conductive welding sheet 14. The first press plate 17 is used to avoid electrically connecting the casing 16 to the first conductive welding sheet 14. The second press plate 18, sleeving the fourth conductive protrusion 132 of the second conductive terminal plate 13, is arranged between the casing 16 and the second conductive welding sheet 15. The second press plate 18 is used to avoid electrically connecting the casing 16 to the second conductive welding sheet 15.

In order to electrically connecting to an external electronic device, the spirally-wound battery structure 1 may further include a first conductive terminal 19 and a second conductive terminal 19′. The first conductive terminal 19 and the second conductive terminal 19′ may be electrically connected to the external electronic device. The first conductive terminal 19, sleeving the second conductive protrusion 122 of the first conductive terminal plate 12, is arranged outside the casing 16. The second conductive terminal 19′, sleeving the fourth conductive protrusion 132 of the second conductive terminal plate 13, arranged outside the casing 16.

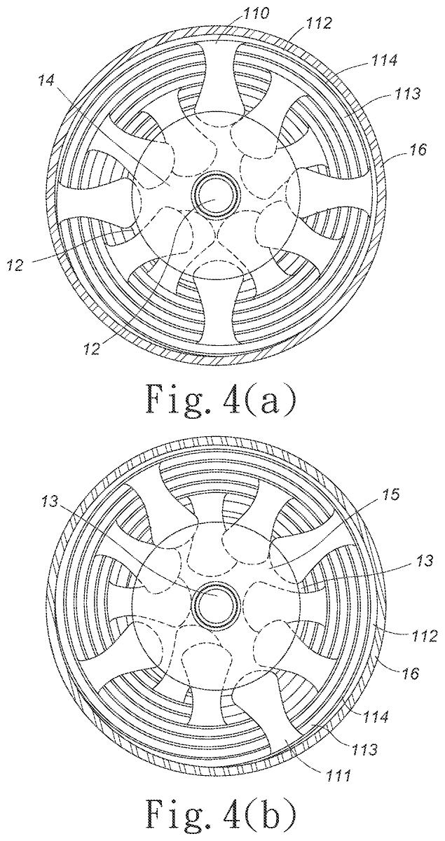

FIG. 4(a) is a schematic diagram illustrating the welding positions of a first conductive welding sheet, a first conductive terminal plate, and first conductive tabs according to an embodiment of the present invention. As illustrated in FIG. 3 and FIG. 4(a), in order to guarantee an electrical connection between the first conductive terminal plate 12 and the first conductive tabs 110 and avoid point discharging and the increase, drift, and divergence the resistance of the spirally-wound battery structure 1 when the first conductive tabs 110 non-uniformly touch the first conductive terminal plate 12, the shortest difference between the outer edge of the first conductive welding sheet 14 and a position where the first conductive welding sheet 14 welds the first conductive tabs 110 and the first conductive terminal plate 12 is R1. R1>0. The length of each of the first conductive tabs 110 that overlaps the first conductive terminal plate 12 and the first conductive welding sheet 14 is larger than or equal to 0.2R1. If the length of each of the first conductive tabs 110 that overlaps the first conductive terminal plate 12 and the first conductive welding sheet 14 is less than 0.2R1, the first conductive tabs 110 will be disconnected from the first conductive terminal plate 12 and the first conductive welding sheet 14 due to shaking. The welding position of the first conductive welding sheet 14 cannot be too close to the edge of the first conductive welding sheet 14. R1 is usually 1 mm. The width of laser is 0.5˜1.5 mm. If the welding position of the first conductive welding sheet 14 is too close to the edge of the first conductive welding sheet 14, laser will easily destroy the first conductive tabs 110 and the insulation film 114 and cause pseudo solder joints to increase the contact impedance of the spirally-wound battery structure 1.

FIG. 4(b) is a schematic diagram illustrating the welding positions of a second conductive welding sheet, a second conductive terminal plate, and second conductive tabs according to an embodiment of the present invention. As illustrated in FIG. 3 and FIG. 4(b), in order to guarantee an electrical connection between the second conductive terminal plate 13 and the second conductive tabs 111 and avoid point discharging and the increase, drift, and divergence the resistance of the spirally-wound battery structure 1 when the second conductive tabs 111 non-uniformly touch the second conductive terminal plate 13, the shortest difference between the outer edge of the second conductive welding sheet 15 and a position where the second conductive welding sheet 15 welds the second conductive tabs 111 and the second conductive terminal plate 13 is R2. R2>0. The length of each of the second conductive tabs 111 that overlaps the second conductive terminal plate 13 and the second conductive welding sheet 15 is larger than or equal to 0.2R2. If the length of each of the second conductive tabs 111 that overlaps the second conductive terminal plate 13 and the second conductive welding sheet 15 is less than 0.2R2, the second conductive tabs 111 will be disconnected from the second conductive terminal plate 13 and the second conductive welding sheet 15 due to shaking. The welding position of the second conductive welding sheet 15 cannot be too close to the edge of the second conductive welding sheet 15. R2 is usually 1 mm. If the welding position of the second conductive welding sheet 15 is too close to the edge of the second conductive welding sheet 15, laser will easily destroy the second conductive tabs 111 and the insulation film 114 and cause pseudo solder joints to increase the contact impedance of the spirally-wound battery structure 1.

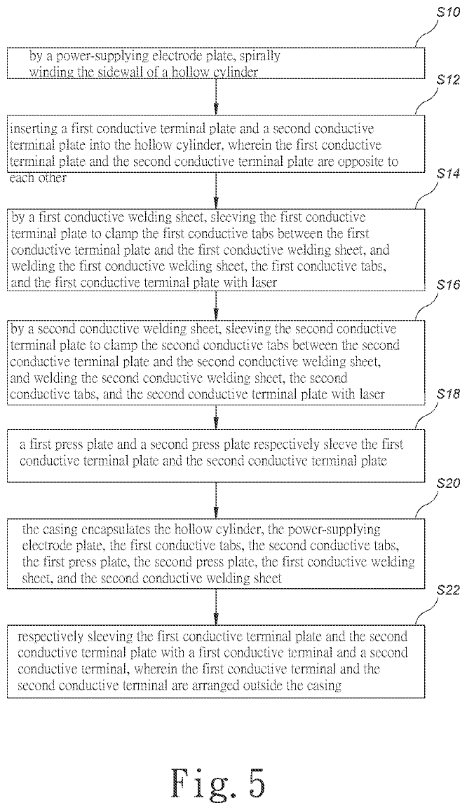

FIG. 5 is a flowchart of a method for producing a spirally-wound battery structure according to an embodiment of the present invention. Referring to FIG. 5 and FIG. 3, the method for producing a spirally-wound battery structure 1 is introduced as follows. In Step S10, the power-supplying electrode plate 11 spirally winds the sidewall of the hollow cylinder 10. In Step S12, the first conductive terminal plate 12 and the second conductive terminal plate 13 are inserted into the hollow cylinder 10, wherein the first conductive terminal plate 12 and the second conductive terminal plate 13 are opposite to each other. In Step S14, the first conductive welding sheet 14 sleeves the first conductive terminal plate 12 to clamp the first conductive tabs 110 between the first conductive terminal plate 12 and the first conductive welding sheet 14. The first conductive welding sheet 14, the first conductive tabs 110, and the first conductive terminal plate 12 are welded with laser. Since the first conductive welding sheet 14, the first conductive tabs 110, and the first conductive terminal plate 12 are rapidly welded with laser, the probability of heat accumulation can be greatly reduced and the first conductive terminal plate 12 and the first conductive welding sheet 14 can reduce the risk of destroying the insulation film 114 at high temperature. Laser points are easily and continuously formed along the edge of the first conductive welding sheet 14 to guarantee an electrical connection between the first conductive terminal plate 12 and the first conductive tabs 110. In Step S16, the second conductive welding sheet 15 sleeves the second conductive terminal plate 13 to clamp the second conductive tabs 111 between the second conductive terminal plate 13 and the second conductive welding sheet 15. The second conductive welding sheet 15, the second conductive tabs 111, and the second conductive terminal plate 13 are welded with laser. Since the second conductive welding sheet 15, the second conductive tabs 111, and the second conductive terminal plate 13 are rapidly welded with laser, the probability of heat accumulation can be greatly reduced and the second conductive terminal plate 13 and the second conductive welding sheet 15 can reduce the risk of destroying the insulation film 114 at high temperature. Laser points are easily and continuously formed along the edge of the second conductive welding sheet 15 to guarantee an electrical connection between the second conductive terminal plate 13 and the second conductive tabs 111. Since the first conductive welding sheet 14 and the second conductive welding sheet 15 weld the first conductive terminal plate 12, the first conductive tabs 110, the second conductive terminal plate 13, and the second conductive tabs 111, there is no need for a secondary precision machining to flatten the welding surfaces of the first conductive terminal plate 12 and the second conductive terminal plate 13. Thus, the spirally-wound battery structure can be automatically produced. Because the first conductive welding sheet 14 and the second conductive welding sheet 15 can consume the energy of laser, the increase, drift, and divergence the resistance of the battery structure 1 are avoided without increasing the widths of the empty foils of the electrode sheets 112 and 113 and the first conductive tabs 110 and the second conductive tabs 111. After Steps S14 and S16, Step S18 is performed. In Step S18, the first press plate 17 and the second press plate 18 respectively sleeve the first conductive terminal plate 12 and the second conductive terminal plate 13. In Step S20, the casing 16 encapsulates the hollow cylinder 10, the power-supplying electrode plate 11, the first conductive tabs 110, the second conductive tabs 111, the first press plate 17, the second press plate 18, the first conductive welding sheet 14, and the second conductive welding sheet 15.

The casing 16 is made of conductive metal. In Step S22, the first conductive terminal 19 and the second conductive terminal 19′ respectively sleeve the first conductive terminal plate 12 and the second conductive terminal plate 13. The first conductive terminal 19 and the second conductive terminal 19′ are arranged outside the casing 16. If the spirally-wound battery structure does not need to electrically connect to the external electrical device, Step S22 can be omitted. In addition, when the casing 16 is made of an insulating material, Step S18 can be omitted. In such a case, the casing 16 encapsulates the hollow cylinder 10, the power-supplying electrode plate 11, the first conductive tabs 110, the second conductive tabs 111, the first conductive welding sheet 14, and the second conductive welding sheet 15 in Step S20.

According to the embodiments provided above, the spirally-wound battery structure and the method for producing the same greatly reduce the probability of heat accumulation, reduce the risk of destroying the insulation film at high temperature, guarantee an electrical connection between the conductive terminal plate and the conductive tabs, and avoid point discharging and the increase, drift, and divergence the resistance of the battery structure when the conductive tabs non-uniformly touch the conductive terminal plate. In the producing process, the conductive terminal plates and the conductive welding sheets can prevent from destroying the insulation film at high temperature instead of increasing the widths of the empty foils of the electrode sheets. Thus, the usage of space within the battery structure is improved to increase the effective area of the electrode sheet and electric power.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method for producing a spirally-wound battery structure, comprising:
by a power-supplying electrode plate, spirally winding a sidewall of a hollow cylinder, wherein the power-supplying electrode plate has a first side edge and a second side edge, the first side edge and the second side edge are opposite to each other, the first side edge extends outward to form first conductive tabs, the second side edge extends outward to form second conductive tabs, the first conductive tabs separate from each other, and the second conductive tabs separate from each other;
inserting a first conductive terminal plate and a second conductive terminal plate into the hollow cylinder, wherein the first conductive terminal plate and the second conductive terminal plate are opposite to each other;
by a first conductive welding sheet, sleeving the first conductive terminal plate to clamp the first conductive tabs between the first conductive terminal plate and the first conductive welding sheet, and welding the first conductive welding sheet, the first conductive tabs, and the first conductive terminal plate with laser;
by a second conductive welding sheet, sleeving the second conductive terminal plate to clamp the second conductive tabs between the second conductive terminal plate and the second conductive welding sheet, and welding the second conductive welding sheet, the second conductive tabs, and the second conductive terminal plate with laser; and by a casing, encapsulating the hollow cylinder, the power-supplying electrode plate, the first conductive tabs, the second conductive tabs, the first conductive welding sheet, and the second conductive welding sheet, wherein the first conductive terminal plate and the second conductive terminal plate penetrate through the casing.

2. The method for producing a spirally-wound battery structure according to claim 1, wherein the power-supplying electrode plate further includes:
a positive electrode sheet with one side edge thereof having the first conductive tabs; and a negative electrode sheet with one side edge thereof having the second conductive tabs, wherein an insulation film is arranged between the positive electrode sheet and the negative electrode sheet, and the positive electrode sheet, the negative electrode sheet, and the insulation film wind the sidewall of the hollow cylinder.

3. The method for producing a spirally-wound battery structure according to claim 1, wherein after the step of welding, the second conductive welding sheet, the second conductive tabs, and the second conductive terminal plate, a first press plate and a second press plate respectively sleeve the first conductive terminal plate and the second conductive terminal plate, and then the casing encapsulates the hollow cylinder, the power-supplying electrode plate, the first conductive tabs, the second conductive tabs, the first press plate, the second press plate, the first conductive welding sheet, and the second conductive welding sheet.

4. The method for producing a spirally-wound battery structure according to claim 1, further comprising a step of respectively sleeving the first conductive terminal plate and the second conductive terminal plate with a first conductive terminal and a second conductive terminal, wherein the first conductive terminal and the second conductive terminal are arranged outside the casing.

5. The method for producing a spirally-wound battery structure according to claim 1, wherein a shortest difference between an outer edge of the first conductive welding sheet and a position where the first conductive welding sheet welds the first conductive tabs and the first conductive terminal plate is R1, R1>0, and a length of each of the first conductive tabs that overlaps the first conductive terminal plate and the first conductive welding sheet is larger than or equal to 0.2R1.

6. The method for producing a spirally-wound battery structure according to claim 1, wherein a shortest difference between an outer edge of the second conductive welding sheet and a position where the second conductive welding sheet welds the second conductive tabs and the second conductive terminal plate is R2, R2>0, and a length of each of the second conductive tabs that overlaps the second conductive terminal plate and the second conductive welding sheet is larger than or equal to 0.2R2.

7. The method for producing a spirally-wound battery structure according to claim 1, wherein a thickness of each of the first conductive welding sheet and the second conductive welding sheet ranges from 100 to 300 μm.

8. A spirally-wound battery structure comprising:
a hollow cylinder;
a power-supplying electrode plate spirally winding a sidewall of the hollow cylinder, wherein the power-supplying electrode plate has a first side edge and a second side edge, the first side edge and the second side edge are opposite to each other, the first side edge extends outward to form first conductive tabs, the second side edge extends outward to form second conductive tabs, the first conductive tabs separate from each other, and the second conductive tabs separate from each other;
a first conductive terminal plate and a second conductive terminal plate arranged opposite to each other and inserted into the hollow cylinder;
a first conductive welding sheet sleeving the first conductive terminal plate, wherein the first conductive tabs are clamped between the first conductive terminal plate and the first conductive welding sheet, and the first conductive welding sheet welds the first conductive terminal plate through the first conductive tabs;
a second conductive welding sheet sleeving the second conductive terminal plate, wherein the second conductive tabs are clamped between the second conductive terminal plate and the second conductive welding sheet, and the second conductive welding sheet welds the second conductive terminal plate through the second conductive tabs; and a casing encapsulating the hollow cylinder, the power-supplying electrode plate, the first conductive tabs, the second conductive tabs, the first conductive welding sheet, and the second conductive welding sheet, wherein the first conductive terminal plate and the second conductive terminal plate penetrate through the casing.

9. The spirally-wound battery structure according to claim 8, wherein the power-supplying electrode plate further includes:
a positive electrode sheet with one side edge thereof having the first conductive tabs; and a negative electrode sheet with one side edge thereof having the second conductive tabs, wherein an insulation film is arranged between the positive electrode sheet and the negative electrode sheet, and the positive electrode sheet, the negative electrode sheet, and the insulation film wind the sidewall of the hollow cylinder.

10. The spirally-wound battery structure according to claim 9, wherein the positive electrode sheet comprises aluminum and the negative electrode sheet comprises copper.

11. The spirally-wound battery structure according to claim 9, wherein the first conductive welding sheet comprises aluminum or stainless steel, and the second conductive welding sheet comprises copper, nickel, stainless steel.

12. The spirally-wound battery structure according to claim 8, further comprising:
a first press plate, sleeving the first conductive terminal plate, arranged between the casing and the first conductive welding sheet; and a second press plate, sleeving the second conductive terminal plate, arranged between the casing and the second conductive welding sheet.

13. The spirally-wound battery structure according to claim 8, further comprising:
a first conductive terminal, sleeving the first conductive terminal plate, arranged outside the casing; and a second conductive terminal, sleeving the second conductive terminal plate, arranged outside the casing.

14. The spirally-wound battery structure according to claim 8, wherein the first conductive terminal plate includes a first conductive plate, a top and a bottom of the first conductive plate respectively have a first conductive protrusion and a second conductive protrusion, the first conductive protrusion is inserted into the hollow cylinder, the first conductive welding sheet sleeves the second conductive protrusion, the first conductive tabs are clamped between the first conductive plate and the first conductive welding sheet, the first conductive welding sheet welds the first conductive plate through the first conductive tabs, and the second conductive protrusion penetrates through the casing.

15. The spirally-wound battery structure according to claim 8, wherein the second conductive terminal plate includes a second conductive plate, a top and a bottom of the second conductive plate respectively have a third conductive protrusion and a fourth conductive protrusion, the third conductive protrusion is inserted into the hollow cylinder, the second conductive welding sheet sleeves the fourth conductive protrusion, the second conductive tabs are clamped between the second conductive plate and the second conductive welding sheet, the second conductive welding sheet welds the second conductive plate through the second conductive tabs, and the fourth conductive protrusion penetrates through the casing.

16. The spirally-wound battery structure according to claim 8, wherein a shortest difference between an outer edge of the first conductive welding sheet and a position where the first conductive welding sheet welds the first conductive tabs and the first conductive terminal plate is R1, R1>0, and a length of each of the first conductive tabs that overlaps the first conductive terminal plate and the first conductive welding sheet is larger than or equal to 0.2R1.

17. The spirally-wound battery structure according to claim 8, wherein a shortest difference between an outer edge of the second conductive welding sheet and a position where the second conductive welding sheet welds the second conductive tabs and the second conductive terminal plate is R2, R2>0, and a length of each of the second conductive tabs that overlaps the second conductive terminal plate and the second conductive welding sheet is larger than or equal to 0.2R2.

18. The spirally-wound battery structure according to claim 8, wherein a thickness of each of the first conductive welding sheet and the second conductive welding sheet ranges from 100 to 300 μm.
